(19) United States
(12) Patent Application Publication
(10) Pub. No.: US 2026/0016998 A1
(43) Pub. Date: Jan. 15, 2026

(54) SYSTEM AND METHOD FOR PREPARING PRINTING DATA

(71) Applicant: XEIKON MANUFACTURING N.V., LIER (BE)

(72) Inventors: Dirk Cesar DE BAER, Berchem (BE); Romain Jan Victor Paul VAN DER GUCHT, Lint (BE); Jürgen Norbert Bart DEVLIEGHERE, Borgerhout (BE)

(73) Assignee: XEIKON MANUFACTURING N.V., LIER (BE)

(21) Appl. No.: 18/993,892

(22) PCT Filed: Jul. 18, 2023
(86) PCT No.: PCT/EP2023/069962

§ 371 Date: Jan. 13, 2025

(30) Foreign Application Priority Data
Jul. 19, 2022 (NL) 2032543

(51) Int. Cl. G06F 3/12

(52) U.S. Cl. CPC G06F 3/1208; G06F 3/1219; G06F 3/1254

(57) ABSTRACT

A system for preparing printing data based on pixel data comprising for a pixel a plurality of different ink or toner color values. The system includes an ink or toner limiting module configured to apply at least one scaling factor function for at least one color combination in order to limit an amount of ink or toner to be applied during printing. Each scaling factor function for a color combination determines scaled color values based on color values of the plurality of color values associated with the color combination.

### FIELD OF INVENTION

The field of the invention relates to systems and methods for preparing printing data. Particular embodiments relate to systems and methods for preparing printing data in order to limit an amount of liquid ink or toner to be applied during printing.

### BACKGROUND

When printing in color with liquid ink or toner, it is known that problems may arise when too much ink or toner is applied during printing. One problem is known as “bleeding” where too much ink/toner is applied, and different colors may get mixed in an undesirable manner. Another problem is known as “feathering” where inks/toners meander on/in the substrate and may cause one color to meander into another color. Also, when using curable inks/toners, if too much ink/toner is applied, there is a risk that only an upper portion of the applied ink/toner is cured and that the curing does not extend through the entire depth of the applied layer.

To avoid such problems, it is known to perform a linear reduction or scaling of the source image data by reducing the ink volume for each pixel by a constant scaling factor, for example by multiplying each of the CMYK values for a pixel with the constant scaling factor.

Further, it is known to perform color management when converting the color values of an image file (e.g., from a CIELab color space) to a color space for printing (e.g., a CMYK color space). More in particular it is known to do color profiling on image files, e.g., using look-up tables. However, this makes it difficult to work with fine gradations. Also, as the required ink limiting is typically dependent on the type of ink/toner, the type of substrate and/or other environmental conditions, it is desirable to be able to change/optimize the look-up tables used. As the preparing of such look-up tables requires many test patches, this is a cumbersome process. Also, it may happen that the final image to be printed is only known during printing, for example when a bar code has to be printed on top of an image from an image file. In such cases, the use of such look-up tables is not appropriate.

### SUMMARY

The object of embodiments of the invention is to provide systems and methods for preparing printing data in an improved manner, whereby bleeding and feathering problems are reduced.

According to a first aspect there is provided a system for preparing printing data based on pixel data comprising for a pixel a plurality of different ink or toner color values (C′M′Y′K′). The system comprises an ink or toner limiting module. The ink or toner limiting module is configured to apply at least one scaling factor function (λ_{CMYK}, λ_{CMY}, λ_{CM}, etc.) for at least one color combination in order to limit an amount of ink or toner to be applied during printing. Each scaling factor function for a color combination determines scaled color values (C″M″Y″K″, C″M″Y″, C″M″, etc.) based on color values of said plurality of color values (C′M′Y′K′, C′M′Y′, C′M′, etc.) associated with said color combination.

By applying a scaling factor function on specific color combinations, the limiting of the amount of ink/toner can be performed in a more targeted and faster manner. For example, for some applications only the YK color combination may be subjected to a scaling factor function whilst for other applications multiple color combinations (e.g., (YK and CM and CY) or (OYK and CMYK), etc.) may be subjected to a scaling factor function.

The scaling factor function is typically a function defining a scaling factor in function of the color values of the specific color combination. Thus, this scaling factor is not a constant factor but is a function of the color values of the specific color combination. For example, the scaling factor may decrease when the sum of the color values for that color combination increases and/or when a maximum value of a color value of the specific color combination decreases. Preferably, each scaling factor function for a color combination is a continuous function of the color values associated with the respective color combination.

Preferably, the system further comprises a linearity compensation module arranged upstream of the ink or toner limiting module and configured to apply, for a pixel with a plurality of different color values (CMYK), a compensation factor function (λ_{C}, λM, λ_{Y}, λ_{K}) for one or more individual color values of said plurality of color values, to obtain new color values (C′M′Y′K′), and to output said new color values into the ink or toner limiting module or into an intermediate module between the linearity compensation module and the ink or toner limiting module. In other words, where the ink or toner limiting module operates on color combinations, the linearity compensation module performs a scaling of individual colors.

Performing the linearity compensation before the ink or toner limiting in the way described above, has the advantage that a very accurate limiting may be performed targeted on specific color combinations. If the linearity compensation were to be done after the ink limiting the ink limiting would not be as good. Also, by performing the linearity compensation before the ink or toner limiting, the calibration process used for determining the scaling factor function and the compensation factor function may be simpler, see further.

The compensation factor function is typically a function defining a compensation factor in function of a single color value. Thus, this compensation factor is not a constant factor but is a function of the color value. Preferably, each compensation factor function is a continuous function of the color value.

Preferably, the at least one color combination comprises a plurality of color combinations. More preferably, the plurality of color combinations comprises at least two different combinations of two colors (Y′K′, C′Y′, C′M′, etc.), and more preferably only combinations of two colors. The inventors have found that by targeting specific combinations of two colors, good results can be obtained without rendering the system unduly complex.

Preferably, the ink or toner limiting module is configured to apply the at least two scaling factor functions so as to determine scaled values for the at least two color combinations and to use, for a color appearing in two or more combinations, a function, such as a minimum function or an average function or a weighted average function or a median function, to determine the scaled color values to be output. For example, when the color combinations CY, CM, CK and YK are used and when the function is a minimum function, the color values may be determined as

Preferably, the ink or toner limiting module is configured to determine for a color combination of said plurality of color combinations, at least one input parameter (f1, f2) derived from the color values of said color combination, and to use said at least one input parameter in the scaling factor function for that color combination. In other words, the at least one input parameter is used to calculate the scaling factor to be used for the specific color combination.

Preferably, the at least one input parameter comprises any one of the following or a combination thereof: a sum of the color values of said color combination, a weighted sum of the color values of said color combination, a maximum color value of the color values of said color combination, a minimum color value of the color values of said color combination, an average of the color values of said color combination, a weighted average of the color values of said color combination, a median of the color values of said color combination.

Preferably, the system further comprises a color management module configured to receive an image file and to generate for each pixel of said image file a plurality of ink or toner color values which are input in the ink or toner limiting module, either directly or in a processed form. For example, the ink or toner limiting module may use directly the values output by the color management module, or the values output by the color management module may first be pre-processed by the linearity compensation module and/or by a merging module (see further). This may be any conventional color management module. For example, the color management module may convert color values from a CIELab color space to a color space for printing, e.g., a CMYK color space.

In an exemplary embodiment, the system further comprises a screening module configured to receive the scaled color values from the ink or toner limiting module and to perform a screening, optionally based on the scaled color values. The screening may determine whether or not pixels have to be printed. The screening may use any suitable type of screening, such as stochastic or FM screening techniques or clustered or AM screening techniques.

In an exemplary embodiment, the linearity compensation module is configured to apply the compensation factor on pixels of multiple page elements and to determine new color values for each page element, and the system further comprises a merging module configured to receive the new color values for each page element, and to merge the color values of each pixel of the page elements to obtain merged new color values (C′M′Y′K′) for each pixel, and to input said merged new color values (C′M′Y′K′) into the ink or toner limiting module.

In a typical embodiment each page element contains for each pixel color values (CMYK) as well as a transparency bit (T) indicating whether the pixel is transparent or not. The merging module then takes into account the transparency bits to determine the new merged color values.

In another exemplary embodiment, the color management module is configured to generate multiple page elements with color values for each pixel, and the system further comprises a merging module configured to receive the color values for each page element, and to merge the color values of each pixel of the multiple page elements to obtain merged color values (CMYK) for each pixel. Preferably, the linearity compensation module is then configured to apply the compensation factor on the merged color values to obtain new color values (C′M′Y′K′), and to input said new color values into the ink or toner limiting module.

In another exemplary embodiment, the ink or toner limiting module is configured to receive multiple page elements and to apply for each page element at least one scaling factor function for at least one color combination in order to obtain scaled color values (C″M″Y″K″, C″M″Y″, C″M″, etc.) for each page element, and the system further comprises a merging module configured to receive the scaled color values for each page element, and to merge the scaled color values of each pixel of the multiple page elements to obtain merged new color values for each pixel.

In another exemplary embodiment, the system further comprises a merging module configured to receive an image file with multiple page elements, to merge the multiple page elements to obtain a merged image file, and to input the merged image file in the color management module.

According to another aspect there is provided a method for configuring a system according to any one of the embodiments disclosed above. The method comprises the steps of:
printing first test patches with different color values for each color combination of said at least one color combination, optionally using at least one associated pre-set scaling factor (λ_{CMYK0}, λ_{CMY0}, λ_{CM0}, etc.);
determining a scaling value ((λ_{CMYK1}, λ_{CMY1}, λ_{CM1}, etc.) to be used in the at least one scaling factor function (λ_{CMYK}, λ_{CMY}, λ_{CM}, etc.) for the at least one color combination, based on the printed first test patches.

Thus, a pre-set scaling factor may be set for each color combination. For example, when the color combination contain two colors the pre-set scaling factor could be 150/200, or when the color combination contain four colors the pre-set scaling factor could be 300/400. The at least one pre-set scaling factor may be based on prior knowledge of ink-coverage problems. It is also possible to start from scratch, without any pre-set scaling factors (or with the pre-set scaling factor being 1).

The operator may then manually analyze the first test patches and/or the first test patches may be analyzed in an automated manner e.g. using automated image interpretation, and the scaling value ((λ_{CMYK1}, λ_{CMY1}, λ_{CM1}, etc.) to be used in the at least one scaling factor function may be determined based on the analysis. The analyzing typically comprises evaluating the print quality of the different patches for artifacts such as feathering or bleeding, or evaluating the curing quality of the different patches. This evaluating can be done manually and/or by automated image interpretation.

The scaling value is typically the scaling value to be used when the color values of the color combination are all at 100%.

Preferably, the method further comprises:
printing for each individual color, a plurality of second test patches with different color values for said individual color, wherein the at least one scaling factor function (λ_{CMYK}, λ_{CMY}, λ_{CM}, etc.) with the determined scaling value is used to limit an amount of ink or toner to be applied during printing; and
determining a compensation factor function (λ_{C}, λ_{M}, λ_{Y}, λ_{K}) for each individual color based on the second test patches.

For example, for each individual color between 15 and 30 second test patches may be printed (with a pre-set compensation factor being 1, i.e. no compensation), and the compensation function may be determined based on the second test patches.

Optionally, the method further comprises, using the determined at least one scaling factor function (λ_{CMYK}, λ_{CMY}, λ_{CM}, etc.) with the determined scaling value and using the determined compensation factor function (λ_{C}, λ_{M}, λ_{Y}, λ_{K}), printing a plurality of third test patches, and determining parameters of the color management module.

By using the determined at least one scaling factor function with the determined scaling value, the number of printed superfluous patches is reduced compared to prior art solutions where such scaling factor function is not used. Because this function is typically a smooth continuous function, all or most patches will be different allowing to improve the accuracy.

According to yet another aspect, there is provided a method for preparing printing data based on pixel data comprising for a pixel a plurality of different ink or toner color values (C′M′Y′K′). The method comprises applying, based on the color values (C′M′Y′K′), at least one scaling factor function (λ_{CMYK}, λ_{CMY}, λ_{CM}, etc.) for at least one color combination, in order to determine scaled color values (C″M″Y″K″, C″M″Y″, C″M″, etc.) based on color values of said plurality of color values (C′M′Y′K′, C′M′Y′, C′M′, etc.) associated with said color combination, in order to limit an amount of ink or toner to be applied during printing.

The technical merits set out above for the system apply mutatis mutandis for the method.

Preferably, the method further comprises, before applying said at least one scaling factor function, applying for a pixel with a plurality of different color values (CMYK), a compensation factor function (λ_{C}, λ_{M}, λ_{Y}, λ_{K}) for each color value of said plurality of color values, to obtain new color values (C′M′Y′K′), and using said new color values (C′M′Y′K′) for the applying of the at least one scaling factor function (λ_{CMYK}, λ_{CMY}, λ_{CM}, etc.).

Preferably, the plurality of color combinations comprises at least combinations of two colors (YK, CY, CM, etc.), and preferably only combinations of two colors.

Preferably, the at least two scaling factor functions are applied so as to determine scaled values for the at least two color combinations and to use, for a color appearing in two or more color combinations, a function, such as a minimum function or an average function or a weighted average function or a median function, to determine the scaled color values to be output. For example, when the color combinations CY, CM, CK and YK are used and when the function is a minimum function,

Optionally, the method further comprises deriving for a color combination of said plurality of color combinations, at least one input parameter (f1, f2) from the color values of said color combination, and using said at least one input parameter as an input of the at least one scaling factor function. The at least one input parameter may comprise any one of the following or a combination thereof: a sum of the color values of said color combination, a weighted sum of the color values of said color combination, a maximum color value of the color values of said color combination, a minimum color value of the color values of said color combination, an average of the color values of the color values of said color combination, a median of the color values of the color values of said color combination.

Preferably, the method further comprises receiving an image file and generating for each pixel of said image file a plurality of ink or toner color values which are used in an optionally further processed form for the applying of the at least one scaling factor function.

According to an exemplary embodiment, the compensation factor function is applied on pixels of multiple page elements and new color values are determined for each page element, and the method further comprises merging the color values of the page elements to obtain merged new color values (C′M′Y′K′) for each color, and using said merged new color values (C′M′Y′K′) for the applying of the at least one scaling factor function.

In another exemplary embodiment, the method comprises generating multiple page elements with color values for each pixel are generated, merging the color values of the multiple page elements to obtain merged color values (CMYK) for each pixel. Preferably, the method then further comprises applying a compensation factor function on the merged color values to obtain new color values (C′M′Y′K′), and using said new color values (C′M′Y′K′) for the applying of the at least one scaling factor function.

In another exemplary embodiment, the method comprises applying for each page element at least one scaling factor function for at least one color combination in order to obtain scaled color values (C″M″Y″K″, C″M″Y″, C″M″, etc.) for each page element, and merging the scaled color values of each pixel of the multiple page elements to obtain merged new color values for each pixel.

In another exemplary embodiment, the method comprises receiving an image file with multiple page elements, merging the multiple page elements to obtain a merged image file, and using the merged image file for generating for each pixel of said merged image file a plurality of ink or toner color values which are used in an optionally further processed form for the applying of the at least one scaling factor function.

According to a further aspect of the invention, there is provided a computer program comprising computer-executable instructions to perform the method, when the program is run on a computer, according to any one of the steps of any one of the embodiments disclosed above.

According to a further aspect of the invention, there is provided a computer device or other hardware device programmed to perform one or more steps of any one of the embodiments of the method disclosed above. According to another aspect there is provided a data storage device encoding a program in machine-readable and machine-executable form to perform one or more steps of any one of the embodiments of the method disclosed above.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIGS. 1, 2, 3 and 4 illustrates schematically four different exemplary embodiments of a system for preparing printing data;

FIGS. 5, 6 and 7 illustrate different exemplary embodiments of an ink or toner limiting module; and

FIG. 8 illustrates an exemplary embodiment of a scaling factor function.

### DESCRIPTION OF EMBODIMENTS

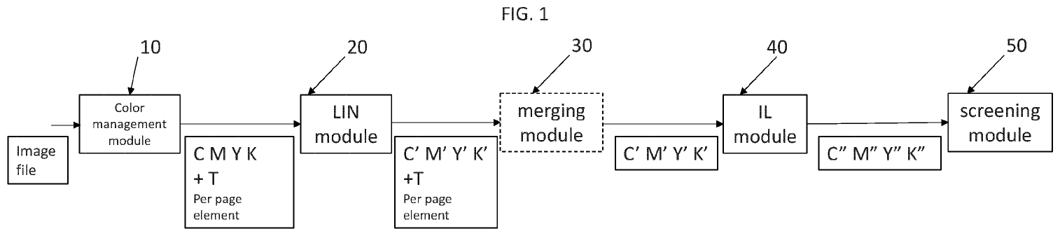

FIG. 1 illustrates a first exemplary embodiment of a system for preparing printing data based on pixel data comprising for a pixel a plurality of different ink or toner color values. The system comprises a color management module 10, a linearity compensation module 20, a merging module 30, an ink or toner limiting module 40 and a screening module 50.

The color management module 10 is configured to receive an image file and to generate multiple page elements with for each pixel of said image file a plurality of ink or toner color CMYK, and optionally a transparency bit T indicating whether the pixel is transparent or not. The color values CMYK output by the color management module 10 may first be pre-processed by the linearity compensation module 20 and by a merging module 30 before being input in processed form in the ink or toner limiting module 40. The color management module 10 may be any conventional color management module.

The linearity compensation module 20 is arranged upstream of the ink or toner limiting module 40 and is configured to apply, for a pixel with a plurality of different color values CMYK, a compensation factor function λ_{C}, λ_{M}, λ_{Y}, λ_{K} for one or more individual color values of said plurality of color values, to obtain new color values C′=λ_{C}.C, M′=λ_{M}.M, Y′=λ_{Y}. Y, K′=λ_{K}.K′, and to output said new color values C′M′Y′K′ per page element into the merging module 30. The compensation factor function λ_{C}, λ_{M}, λ_{Y}, λ_{K} is typically a function defining a compensation factor in function of a single color value C, M, Y, K. Thus, this compensation factor λ_{C}, λ_{M}, λ_{Y}, λ_{K} is not a constant factor but is a function of the color value. Preferably, each compensation factor function is a continuous function of the color value.

In the illustrated embodiment, the linearity compensation module 20 is configured to apply the compensation factor on pixels of multiple page elements and to determine new color values for each page element, and the system further comprises a merging module 30 configured to receive the new color values for each page element, and to merge the color values of each pixel of the page elements to obtain merged new color values C′M′Y′K′ for each pixel, and to input said merged new color values C′M′Y′K′ into the ink or toner limiting module 40. The merging module 30 takes into account the transparency bits T to determine the new merged color values. In other embodiments, the merging may be done during the color profiling or immediately after the color profiling.

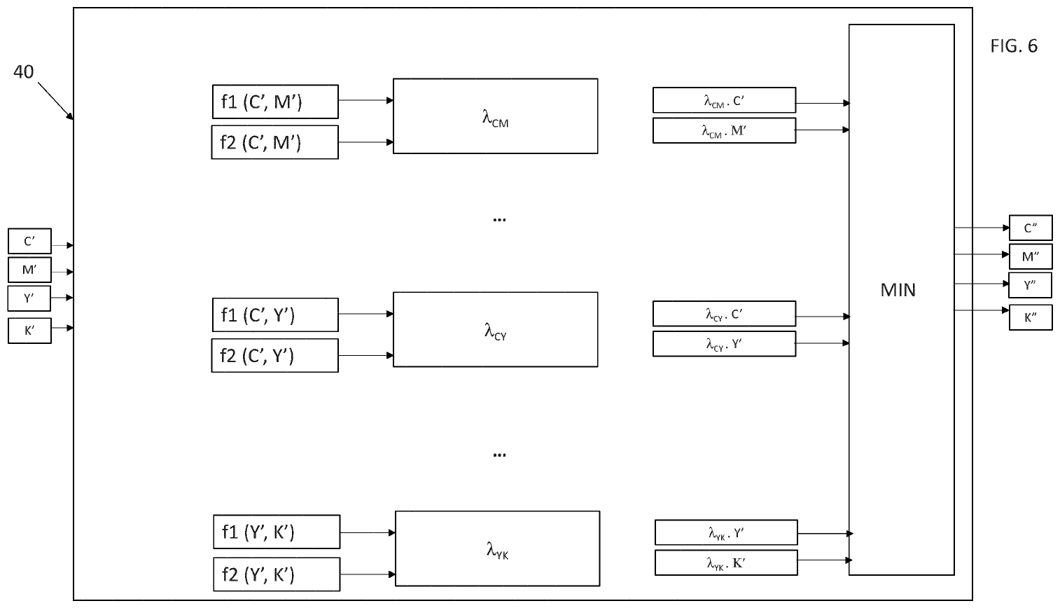

The ink or toner limiting module 40 is configured to apply at least one scaling factor function (λ_{CMYK} or λ_{CMY} or λ_{CM}, etc.) for at least one color combination in order to limit an amount of ink or toner to be applied during printing. Each scaling factor function for a color combination determines scaled color values, for example (C″=λ_{CMYK}.C′, M″=λ_{CMYK}.M′, Y″=λ_{CMYK}.Y′, K″=λ_{CMYK}.K′) or (C″=λ_{CMY}.C′, M″=λ_{CMY}.M′, Y″=λ_{CMY}.Y′, K″=K′) or (C″=λ_{CM}.C′, M″λ_{CM}.M′, Y″=Y′, K″=K′) or a combination thereof, based on color values associated with the specific color combination. When two color scaling factor functions are applied for a certain color, the minimum of the two scaled color values may be used, see also the embodiment of FIG. 6 which will be discussed below.

By applying a scaling factor function on specific color combinations, the limiting of the amount of ink/toner can be performed in a more targeted and fast manner. For example, for some applications only the YK color combination may be subjected to a scaling factor function whilst for other applications multiple color combinations (e.g., (YK and CM and CY) or (OYK and CMYK), etc.) may be subjected to a scaling factor function.

Thus, the ink or toner limiting module 40 operates on color combinations, whilst the linearity compensation module 20 performs a scaling of individual colors. Arranging the linearity compensation module 20 upstream of the ink or toner limiting module 40 in the way described above, has the advantage that a very accurate limiting may be performed targeted on specific color combinations.

The screening module 50 is configured to receive the scaled color values from the ink or toner limiting module 40 and to perform a screening, optionally based on the scaled color values. The screening may determine whether or not pixels have to be printed. The screening may use any suitable type of screening, such as stochastic or FM screening techniques or clustered or AM screening techniques.

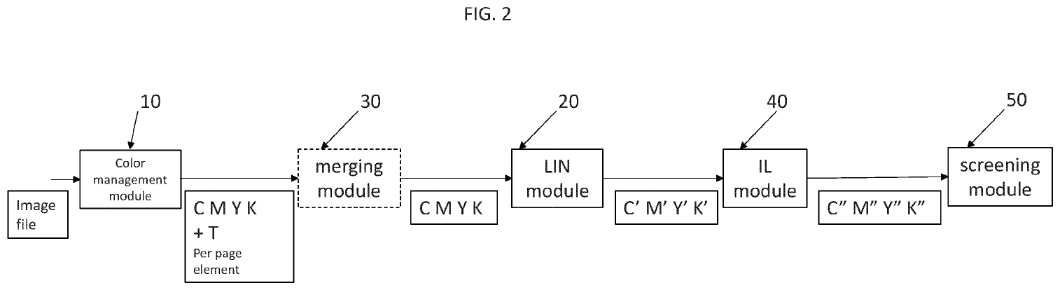

FIG. 2 illustrates another exemplary embodiment for which the same or similar components have been indicated with the same reference numerals. In the embodiment of FIG. 2, the merging by the merging module 30 is done before the linearity compensation by the linearity compensation module 20. The color management module 10 is configured to generate multiple page elements with color values for each pixel, and the merging module 30 is configured to receive the color values for each page element, and to merge the color values of each pixel of the multiple page elements to obtain merged color values CMYK for each pixel. The linearity compensation module 20 is then configured to apply the compensation factor on the merged color values to obtain new color values C′M′Y′K′, and to input said new color values into the ink or toner limiting module 40. Such an embodiment may be possible when all page elements use the same linearity compensation.

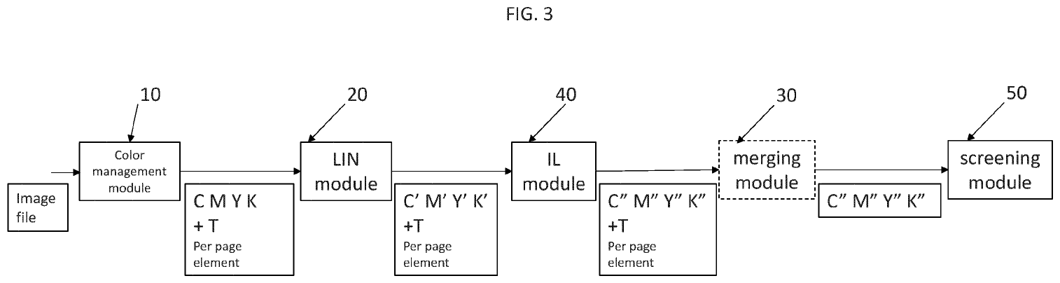

FIG. 3 illustrates another exemplary embodiment for which the same or similar components have been indicated with the same reference numerals. In the embodiment of FIG. 3, the merging by the merging module 30 is done downstream of the ink or toner limiting module 10. The ink or toner limiting module 40 is configured to receive multiple page elements and to apply for each page element at least one scaling factor function for at least one color combination in order to obtain scaled color values C″M″Y″K″ for each page element. The merging module 30 is configured to receive the scaled color values for each page element, and to merge the scaled color values of each pixel of the multiple page elements to obtain merged new color values for each pixel.

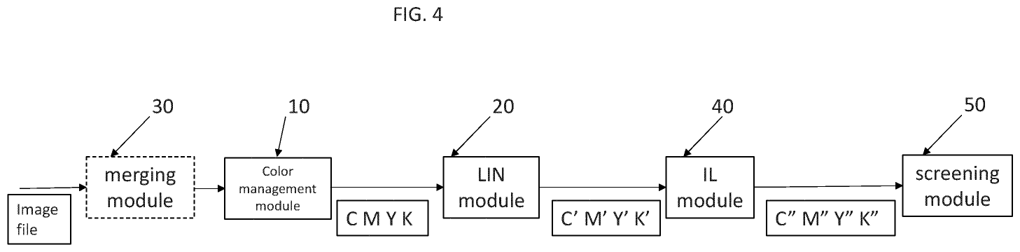

FIG. 4 illustrates another exemplary embodiment for which the same or similar components have been indicated with the same reference numerals. In the embodiment of FIG. 4, the merging by the merging module 30 is done before the color profiling by the color management module 10. The merging module 30 is configured to receive an image file with multiple page elements, to merge the multiple page elements to obtain a merged image file, and to input the merged image file in the color management module 10.

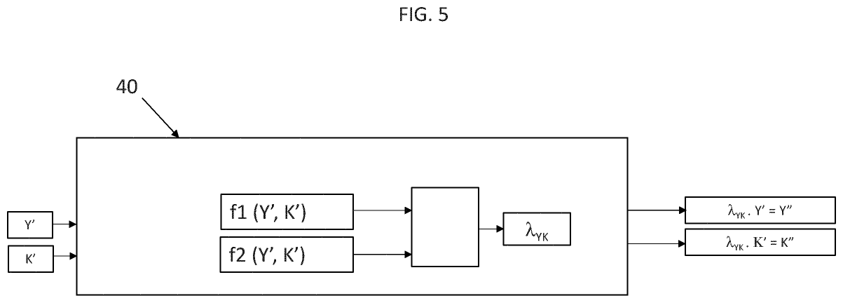

FIG. 5 illustrates a first possible implementation of an ink or toner limiting module 40. The ink or toner limiting module 40 is configured to apply a single scaling factor function λ_{YK} for the color combination YK. The scaling factor function for the color combination YK determines scaled color values C″=C′, M″=M′, Y″=λ_{YK}.Y′, K″=λ_{YK}.K′. In other words, only the color values for Y and K are scaled.

Preferably, the ink or toner limiting module 40 is configured to determine for the color combination YK, two input parameters f1, f2 derived from the color values Y′K′, and to use said at input parameters f1, f2 for determining the value of the scaling factor function for that color combination. Preferably, the input parameters f1, f2 comprises any one of the following or a combination thereof: a sum of the color values of said color combination, a weighted sum of the color values of said color combination, a maximum color value of the color values of said color combination, a minimum color value of the color values of said color combination, an average of the color values of said color combination, a weighted average of the color values of said color combination, a median of the color values of said color combination. For example, f1=Y′+K′ and f2=max(Y′, K′).

FIG. 6 illustrates another possible implementation of an ink or toner limiting module 40. The ink or toner limiting module 40 is configured to apply three scaling factor functions λ_{CM}, λ_{CY}, λ_{YK} for the color combinations CM, CY and YK. Because the colors C and Y appear in two of the three color combinations, a minimum of the scaled values for C and Y is taken. Thus, the scaled color values become C″=min (λ_{CM}, C′, λ_{CY}, C′), M″=λ_{CM}. M′, Y″=min (λ_{YK}, Y′, λ_{CY}. Y′), K″=λ_{YK}. Y′, λ_{CY}. Y′) In other words, all color values are scaled based on a scaling for three color combinations of two colors.

Preferably, the ink or toner limiting module 40 is configured to determine for each color combination CM, CY and YK, two input parameters f1, f2 derived from the color values C′M′, C′Y′ and Y′K′, and to use said at input parameters f1, f2 for determining the value of the scaling factor function for that color combination. Preferably, the input parameters f1, f2 comprises any one of the following or a combination thereof: a sum of the color values of said color combination, a weighted sum of the color values of said color combination, a maximum color value of the color values of said color combination, a minimum color value of the color values of said color combination, an average of the color values of said color combination, a weighted average of the color values of said color combination, a median of the color values of said color combination.

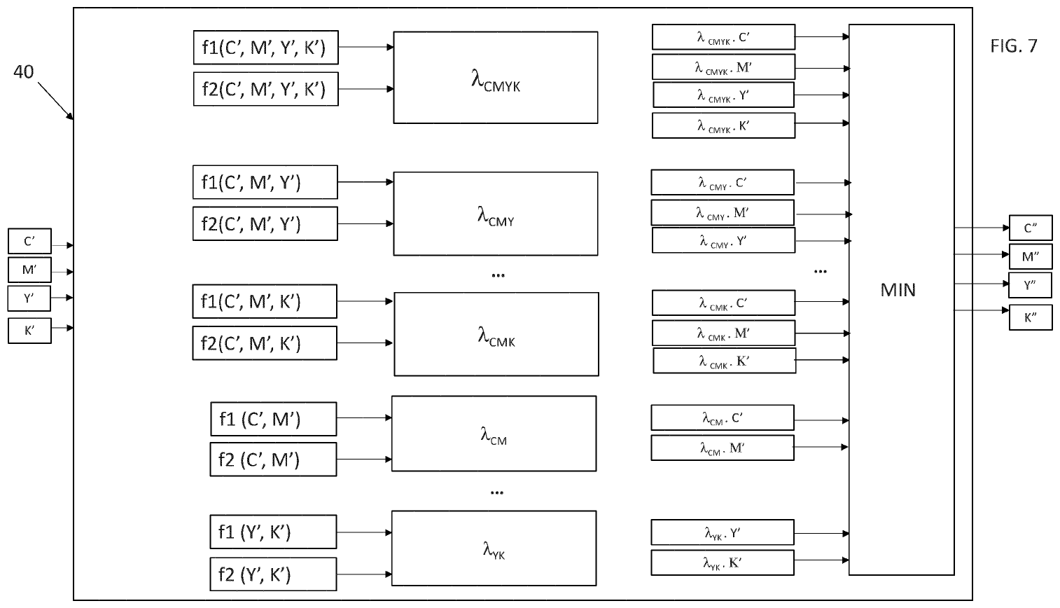

FIG. 7 illustrates another possible implementation of an ink or toner limiting module 40. The ink or toner limiting module 40 is configured to apply scaling factor functions λ_{CMYK}, λ_{CMY}, λ_{CMK}, λ_{CYK}, λ_{MYK}, λ_{YM}, λ_{CM}, λ_{CY}, λ_{YK}, λ_{CK}, λ_{MK} for all color combinations. Because the colors CMYK appear in multiple color combinations, a minimum of the scaled values for CMYK is taken. Thus, the scaled color values become C″=min(λ_{CMYK}.C′, λ_{CMY}.C′, λ_{CMK}.C′, λ_{CM}. C′, λ_{CM}.C′, λ_{CY}.C′, λ_{CK}.C′), etc. In other words, all color values are scaled based on a scaling for all color combinations of two, three or four colors.

Preferably, the ink or toner limiting module 40 is configured to determine for all color combinations CMYK, CMY, CMK, CYK, MYK, CM, CY, CK, MY, MK and YK, two input parameters f1, f2 derived from the respective color values, and to use said at input parameters f1, f2 for determining the value of the scaling factor function for that color combination. Preferably, the input parameters f1, f2 comprises any one of the following or a combination thereof: a sum of the color values of said color combination, a weighted sum of the color values of said color combination, a maximum color value of the color values of said color combination, a minimum color value of the color values of said color combination, an average of the color values of said color combination, a weighted average of the color values of said color combination, a median of the color values of said color combination.

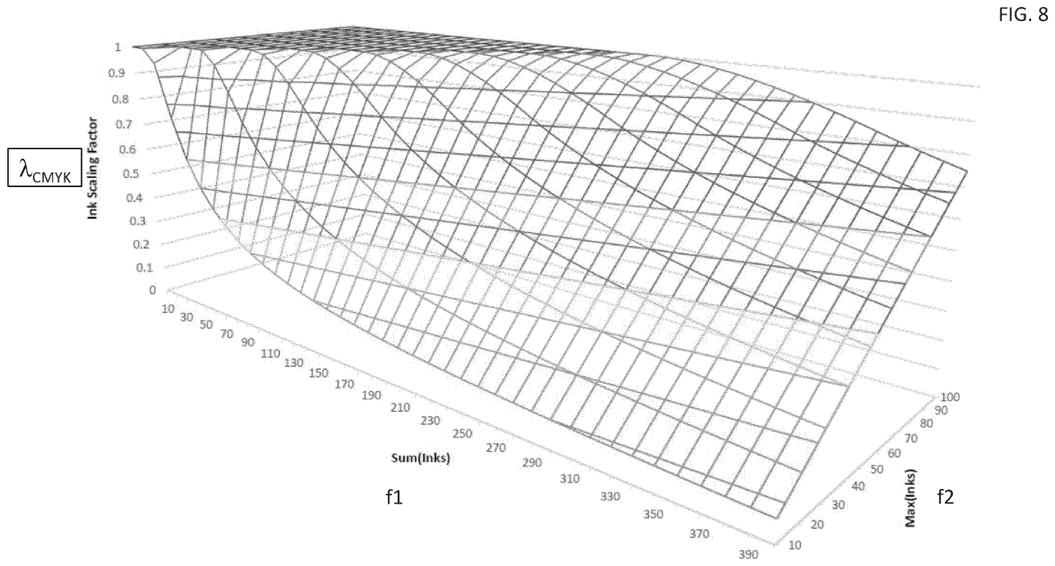

FIG. 8 illustrates a possible scaling factor function λ_{CMYK} for scaling a combination of four color values, wherein f1 is the sum of the color values CMYK and f2 is the maximum of the color values CMYK. It is noted that not all points of the graph are possible (for example, when the maximum value is 50, the sum cannot be more than 200, so points with a maximum value of 50 and a sum above 200 are not possible). Preferably, as illustrated, the scaling factor function is a continuous function of the color values associated with the respective color combination. In the illustrated example the scaling factor λ_{CMYK} lower significantly when C+M+Y+K exceeds approximately 300.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the figures, including any functional blocks labelled as “modules”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “module” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

Whilst the principles of the invention have been set out above in connection with specific embodiments, it is to be understood that this description is merely made by way of example and not as a limitation of the scope of protection which is determined by the appended claims.

1. A system for preparing printing data based on pixel data comprising for a pixel a plurality of different ink or toner color values, said system comprising:
an ink or toner limiting module configured to apply at least two scaling factor functions for at least two color combinations in order to limit an amount of ink or toner to be applied during printing, wherein each scaling factor function for a color combination determines scaled color values based on color values of said plurality of color values associated with said color combination;
wherein the at least two color combinations comprise at least two different combinations of two colors.

2. The system of claim 1, further comprising a linearity compensation module arranged upstream of the ink or toner limiting module and configured to apply, for a pixel with a plurality of different color values, a compensation factor function for one or more individual color values of said plurality of color values, to obtain new color values, and to output said new color values into the ink or toner limiting module or into an intermediate module between the linearity compensation module and the ink or toner limiting module.

3. The system of claim 1, wherein the ink or toner limiting module is configured to apply the at least two scaling factor functions so as to determine scaled values for the at least two color combinations and, for a color appearing in two or more combinations, to use a function, such as a minimum function, to determine the scaled color values, wherein preferably the at least two color combinations comprise only combinations of two colors.

4. (canceled)

5. The system of claim 1, wherein the ink or toner limiting module is configured to determine for a color combination of said at least two color combinations, at least one input parameter derived from the color values of said color combination, and to use said at least one input parameter in the scaling factor function for that color combination.

6. The system of claim 5, wherein said at least one input parameter comprises any one of the following or a combination thereof: a sum of the color values of said color combination, a weighted sum of the color values of said color combination, a maximum color value of the color values of said color combination, a minimum color value of the color values of said color combination, an average of the color values of said color combination, a weighted average of the color values of said color combination, a median of the color values of said color combination.

7. The system of claim 1, further comprising a color management module configured to receive an image file and to generate for each pixel of said image file a plurality of ink or toner color values which are input in the ink or toner limiting module, either directly or in a processed form.

8. The system of claim 1, further comprising a screening module configured to receive the scaled color values and to perform a screening, optionally based on the scaled color values.

9. The system of claim 2, wherein the linearity compensation module is configured to apply the compensation factor on pixels of multiple page elements and to determine new color values for each page element, and wherein the system further comprises a merging module configured to receive the new color values for each page element, and to merge the color values of each pixel of the multiple page elements to obtain merged new color values for each pixel, and to input said merged new color values into the ink or toner limiting module.

10. The system of claim 7, wherein the color management module is configured to generate multiple page elements with color values for each pixel, and wherein the system further comprises a merging module configured to receive the color values for each page element, and to merge the color values of each pixel of the multiple page elements to obtain merged color values for each pixel.

11. The system of claims 2, wherein the color management module is configured to generate multiple page elements with color values for each pixel, and wherein the system further comprises a merging module configured to receive the color values for each page element, and to merge the color values of each pixel of the multiple page elements to obtain merged color values for each pixel; and wherein the linearity compensation module is configured to apply the compensation factor function on the merged color values to obtain new color values, and to input said new color values into the ink or toner limiting module.

12. The system of claim 1, wherein the ink or toner limiting module is configured to receive multiple page elements and to apply for each page element at least one scaling factor function for at least one color combination in order to obtain scaled color values for each page element, and wherein the system further comprises a merging module configured to receive the scaled color values for each page element, and to merge the scaled color values of each pixel of the multiple page elements to obtain merged new color values for each pixel.

13. The system of claim 7, further comprising a merging module configured to receive an image file with multiple page elements, to merge the multiple page elements to obtain a merged image file, and to input the merged image file in the color management module.

14. A method for configuring a system according to claim 1, comprising the steps of:
printing first test patches with different color values for each color combination of said at least two color combinations, optionally using at least one associated pre-set scaling factor;
determining a scaling value to be used in the at least two scaling factor functions for the at least two color combinations, based on the printed first test patches.

15. The method of claim 14, further comprising:
printing for each individual color, a plurality of second test patches with different color values for said individual color, wherein the at least two scaling factor functions with the determined values are used to limit an amount of ink or toner to be applied during printing; and
determining a compensation factor function for each individual color based on the second test patches.

16. (canceled)

17. A method for preparing printing data based on pixel data comprising for a pixel a plurality of different ink or toner color values, said method comprising:
applying, based on the color values, at least two scaling factor functions for at least two color combinations, in order to determine scaled color values based on color values of said plurality of color values associated with said color combination, in order to limit an amount of ink or toner to be applied during printing;
wherein the at least two color combinations comprise at least two different combinations of two colors.

18. The method of claim 17, further comprising, before applying said at least two scaling factor functions, applying for a pixel with a plurality of different color values, a compensation factor function for each color value of said plurality of color values, to obtain new color values, and using said new color values for the applying of the at least two scaling factor functions, wherein optionally the at least two color combinations comprise only combinations of two colors.

19. (canceled)

20. The method of claim 17, further comprising deriving for a color combination of said at least two color combinations, at least one input parameter from the color values of said color combination, and using said at least one input parameter as an input of the at least two scaling factor functions, wherein preferably said at least one input parameter comprises any one of the following or a combination thereof: a sum of the color values of said color combination, a weighted sum of the color values of said color combination, a maximum color value of the color values of said color combination, a minimum color value of the color values of said color combination, an average of the color values of the color values of said color combination, a median of the color values of the color values of said color combination.

21. (canceled)

22. The method of claim 17, further comprising receiving an image file and generating for each pixel of said image file a plurality of ink or toner color values which are used in an optionally further processed form for the applying of the at least two scaling factor functions.

23. The method of claim 17, wherein the compensation factor function is applied on pixels of multiple page elements and new color values are determined for each page element, and further comprising merging the color values of the page elements to obtain merged new color values for each color, and using said merged new color values for the applying of the at least two scaling factor functions.

24. A computer program product comprising computer-executable instructions to perform the method, when the program is run on a computer, of claim 17.
